(19) United States
(12) Patent Application Publication
(10) Pub. No.: US 2013/0281214 A1
(43) Pub. Date: Oct. 24, 2013

(54) GAME SYSTEM

(71) Applicants: Yuji Kishimoto, Tokyo (JP); Eishi Kuroda, Tokyo (JP)

(72) Inventors: Yuji Kishimoto, Tokyo (JP); Eishi Kuroda, Tokyo (JP)

(21) Appl. No.: 13/852,815

(22) Filed: Mar. 28, 2013

(30) Foreign Application Priority Data
Apr. 20, 2012 (JP) 2012-097151

(51) Int. Cl. A63F 13/00

(52) U.S. Cl. CPC A63F 13/005
USPC 463/40

(57) ABSTRACT

One object is to provide a game system that can technically restrain real money trade. In accordance with one aspect, a game system according to an embodiment of the present invention is composed of: a trade rate information generating unit configured to generate trade rate information; a trade rate information presenting unit configured to present the trade rate information in the game being played by a third player; a trade condition updating request receiving unit configured to receive from the third player a first trade condition updating; a trade condition updating unit configured to update the first trade condition information so as to include the trade quantity and player identification information of the third player included in the first trade condition updating request.

### CROSS-REFERENCE TO RELATED APPLICATIONS

This application is based on and claims the benefit of priority from Japanese Patent Application Serial No. 2012-097151 (filed on Apr. 20, 2012), the contents of which are hereby incorporated by reference in their entirety.

### TECHNICAL FIELD

The present invention relates to a game system.

### BACKGROUND

So-called online games have become popular, wherein a game system implemented on a server device provides game data to a plurality of terminal devices via a communication network, and the plurality of terminal devices simultaneously progress a game using the provided game data.

Online games may have built-in functions for exchanging cards and items such as weapons used in the games between players, so as to encourage social interaction between players. For example, Japanese Patent Application Publication No. 2009-187143 (the “'143 Publication”) discloses a technique for exchange of items used in an online game between players.

As disclosed in the '143 Publication, some players sell and buy cards and items in real currency; this is called real money trade. If the real money trade is left uncontrolled, only part of players can play the game with a remarkably advantageous condition; this may cause loss of game balance. Thus, online game providers prohibit real money trade in user agreement and suspend play of the game for users who has violated the user agreement, thereby restraining the real money trade.

### SUMMARY

However, real money trade cannot be sufficiently restrained by strict application of user agreement. Therefore, various embodiments of the present invention provide a game system that technically restrains real money trade.

A game system according to an embodiment of the present invention comprises: a game program storage unit configured to store a game program for performing a game; an owned quantity storage unit configured to store owned quantities of first game medium and second game medium owned by each of a plurality of players of the game, in association with player identification information unique to each of the plurality of players; a trade condition information storage unit configured to store first trade condition information and second trade condition information in association with each other, the first trade condition information including a trade quantity of the first game medium set by a first player included in the plurality of players, and player identification information of the first player, the second trade condition information including a trade quantity of the second game medium set by a second player included in the plurality of players, and player identification information of the second player; a trade rate information generating unit configured to generate trade rate information, the trade rate information including the trade quantity of the first game medium and the trade quantity of the second game medium stored on the trade condition information storage unit, and the trade rate information not including player specifying information capable of specifying each of the plurality of players; a trade rate information presenting unit configured to present the trade rate information in the game being played by a third player included in the plurality of players; a trade condition updating request receiving unit configured to receive a first trade condition updating request from the third player, the first trade condition updating request including a trade quantity of the first game medium, the trade quantity being set by the third player; a trade condition updating unit configured to update the first trade condition information so as to include the trade quantity and player identification information of the third player included in the first trade condition updating request, if the first trade condition updating request is received prior to trade termination time, and the trade quantity included in the first trade condition updating request is greater than the trade quantity included in the first trade condition information; and an owned quantity updating unit configured to update the owned quantities of the first game medium and the second game medium stored on the owned quantity storage unit, based on the first trade condition information and the second trade condition information stored on the trade condition information storage unit at the trade termination time.

A method using a computer according to an embodiment of the present invention comprises the steps of: storing game programs for performing games; storing owned quantities of first game medium and second game medium owned by each of a plurality of players of the game, in association with player identification information unique to each of the plurality of players; storing first trade condition information and second trade condition information in association with each other, the first trade condition information including a trade quantity of the first game medium set by a first player included in the plurality of players, and player identification information of the first player, the second trade condition information including a trade quantity of the second game medium set by a second player included in the plurality of players, and player identification information of the second player; generating trade rate information, the trade rate information including the trade quantity of the first game medium and the trade quantity of the second game medium stored in the trade condition information storing step, the trade rate information not including player specifying information capable of specifying each of the plurality of players; presenting the trade rate information in the game being played by a third player included in the plurality of players; receiving a first trade condition updating request from the third player, the first trade condition updating request including a trade quantity of the first game medium, the trade quantity being set by the third player; if the first trade condition updating request is received prior to trade termination time, and the trade quantity included in the first trade condition updating request is greater than the trade quantity included in the first trade condition information, updating the first trade condition information so as to include the trade quantity and player identification information of the third player included in the first trade condition updating request; and updating the owned quantities of the first game medium and the second game medium stored on the owned quantity storage unit, based on the first trade condition information and the second trade condition information stored in the trade condition information storing step and remaining at the trade termination time.

Various embodiments of the present invention provide a game system that technically restrains real money trade.

### BRIEF DESCRIPTION OF THE DRAWINGS

FIG. 1 is a block diagram schematically illustrating the architecture of a game system according to an embodiment of the present invention.

FIG. 2 is a block diagram schematically illustrating the architecture of a terminal device used in a game system according to an embodiment of the present invention.

FIG. 3 is a block diagram schematically illustrating the functionality of a server device used in a game system according to an embodiment of the present invention.

FIG. 4 shows an example of player specifying information table.

FIG. 5 shows an example of owned quantity management table used in a game system according to an embodiment of the present invention.

FIG. 6 shows an example of trade condition information management table used in a game system according to an embodiment of the present invention.

FIG. 7 shows an example of updated trade condition information management table.

FIG. 8 shows an example of updated owned quantity management table.

FIG. 9 is a flowchart showing an example of process for exchanging game media using a game system according to an embodiment of the present invention.

FIG. 10 shows an example of an item displayed in a game system according to an embodiment of the present invention.

FIG. 11 shows an example of a trade condition setting screen for setting trade condition information of an item in a game system according to an embodiment of the present invention.

FIG. 12 shows an example of a trade rate screen for displaying trade rate information in a game system according to an embodiment of the present invention.

FIG. 13 shows an example of a trade rate setting screen for setting a trade rate of an item in a game system according to an embodiment of the present invention.

FIG. 14 shows an example of a trade rate screen for displaying trade rate information in a game system according to another embodiment of the present invention.

FIG. 15 shows an example of a trade rate setting screen for setting a trade rate of an item in a game system according to the other embodiment of the present invention.

FIG. 16 shows an example of group management table used in a game system according to an embodiment of the present invention.

FIG. 17 shows an example of group classification table used in a game system according to an embodiment of the present invention.

FIG. 18 shows an example of player management table used in a game system according to an embodiment of the present invention.

### DESCRIPTION OF EXAMPLE EMBODIMENTS

Some embodiments of the present invention will be described hereinafter with reference to the drawings. In the drawings, the same components are denoted by the same reference numerals.

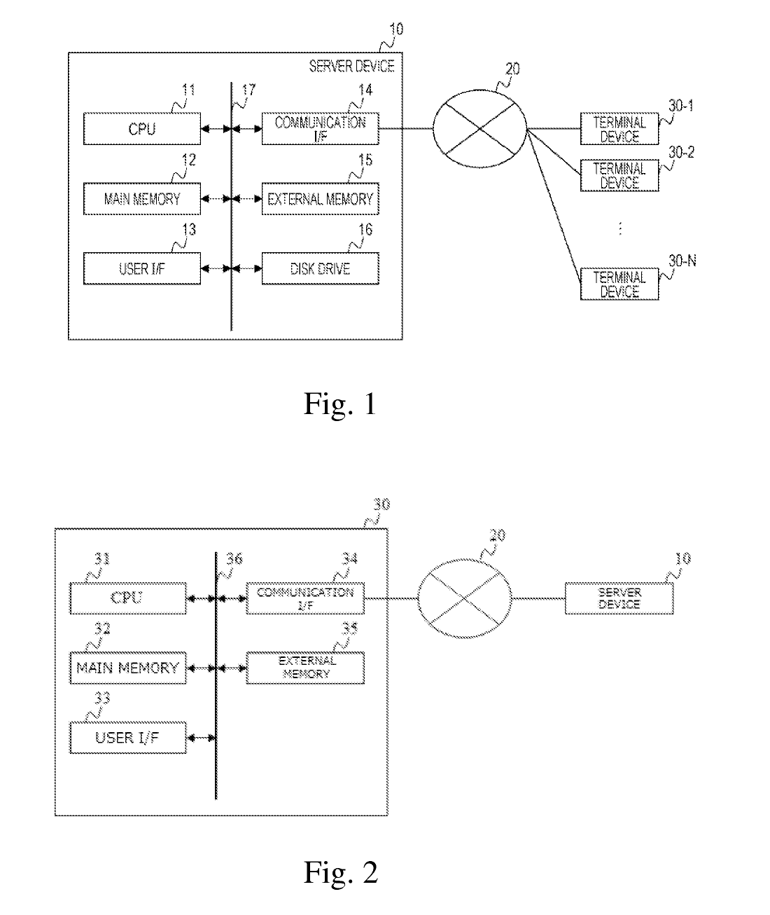

FIG. 1 is a block diagram schematically illustrating the architecture of a game system according to an embodiment of the present invention. As illustrated in FIG. 1, in the embodiment of the present invention, an online game server device 10 (hereinafter also referred to simply as the “server device 10”) may be communicatively connected to a plurality of terminal devices 30-1, 30-2, . . . , and 30-N (hereinafter also collectively referred to as the “terminal devices 30”), each having a communication function, via a communication network 20 such as the Internet. The server device 10 is an example of a device implementing part or all of a game system according to an embodiment of the present invention.

As illustrated in FIG. 1, the server device 10 may include a central processing unit (CPU) 11, a main memory 12, a user interface (I/F) 13, a communication I/F 14, an external memory 15, and a disk drive 16, and these components are electrically connected to one another via a bus 17. The CPU 11 may load an operating system and various programs for controlling the progress of an online game into the main memory 12 from the external memory 15, and execute commands included in the loaded programs. The main memory 12 may be used to store a program to be executed by the CPU 11, and may formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive, and stores various programs such as a game program for allowing the terminal device 30 to execute an online game and a control program for controlling the progress of the online game. The game program may be created using, for example, Adobe Flash™, which is a format developed by Adobe Systems Incorporated to handle moving images, games, and the like. The game program created using Adobe Flash™ may be stored in the external memory 15 as a small web format (SWF) file. The game program will be described below. The disk drive 16 may read data stored in a storage medium such as a compact disc read only memory (CD-ROM), digital versatile disc read only memory (DVD-ROM), or DVD Recordable (DVD-R) disc, or writes data to such a storage medium. For example, data of a game program or the like stored in a storage medium may be read by the disk drive 16, and may be installed into the external memory 15.

The terminal device 30 may be any information processing device capable of executing and operating a game program stored on the server device 10 and displayed on a web browser, non-limiting examples of the terminal device 30 including a mobile phone, a smartphone, a game console, a personal computer, a tablet, or an electronic book reader. Additionally, the terminal device 30 may be capable of receiving a game program from the server device 10 through a communication I/F 34 (described later) for executing the game.

The architecture of these various terminal devices 30 will be described with reference to FIG. 2. FIG. 2 is a block diagram schematically illustrating the architecture of a terminal device 30 according to an embodiment of the present invention. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and execute commands included in the loaded programs. The main memory 32 may store a program to be executed by the CPU 31, and may be formed of, for example, a dynamic random access memory (DRAM).

The user I/F 33 may include, for example, an information input device such as a touch panel, a keyboard, a button, and a mouse for accepting an input from a player (user), and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server device 10 via the communication network 20.

The external memory 35 may comprise, for example, a magnetic disk drive or a flash memory and stores various programs such as an operating system. When receiving a game program from the server device 10 via the communication I/F 34, the external memory 35 may store the received game program.

The terminal device 30 having such architecture may be provided with, for example, browser software for interpreting a hypertext markup language (HTML) file and displaying a screen, and plug-in software (e.g., Flash Player distributed by Adobe Systems Incorporated) incorporated in the browser software. The terminal device 30 may acquire an SWF file embedded in an HTML file from the server device 10, and execute the SWF file using the browser software and plug-in software, and therefore the user of the terminal device 30, or a game player, may be provided with a gaming function.

A game program will be described with reference to FIGS. 1 and 2. The game program may be stored on the external memory 15 of the server device 10 in various forms. For example, the game program may be provided as a piece of application software executable on various application execution platforms. The player is able to execute or operate a game application using the terminal device 30.

The external memory 15 of the server device 10 may store game programs for executing or operating various games executable or operable on the terminal device 30. The game programs may be created using, for example, script languages such as ActionScript™ and JavaScript™, or object-oriented programming languages such as Objective-C™ and Java™. The game programs may be executed and/or operated on a platform installed on the terminal device 30. A game program to be stored on the external memory 15 may be produced by modifying a web page created in a markup language such as HTML5 by using a style sheet such as Cascading Style Sheet 3 (CSS3). Such a web page created in a markup language may be executed or operated by the browser software installed on the terminal device 30. The external memory 15 of the server device 10 may store a desired number of game programs, and a game program for executing and/or operating a game selected by the terminal device 30 may be provided to a desired number of terminal devices 30 via the communication I/F 14 in accordance with control of the CPU 11. In the terminal device 30, the game program sent from the server device 10 may be transferred to the external memory 35 via the communication I/F 34 in accordance with control of the CPU 31.

The terminal device 30 may execute or operate the game program to play various games such as action games, role-playing games, baseball interactive games, and card games. The games implemented by the game program are not limited to those explicitly disclosed herein. When a game is executed, for example, animation or an operation icon designated by the program may be displayed on a screen of the terminal device 30. The player may enter an instruction for causing the game to progress using an input interface (e.g., a touch screen or a button) of the terminal device 30. The instruction entered by the player may be transmitted to the server device 10 through the browser of the terminal device 30 or a platform function such as NgCore™. The terminal device 30 may send information indicating various parameters (such as the number of game points earned and information concerning obtained items), which is used in the game, and information indicating the status of the game (such as information specifying which mission has been fulfilled) to the server device 10, if necessary. The server device 10 may manage the progress of the individual players in the game in accordance with information received from the plurality of terminal devices 30, such as instructions, information indicating the parameters, and information indicating the statuses. Thus, each player is able to resume the interrupted game from the point where it was interrupted, on the basis of the information concerning the progress of the game held in the server device 10.

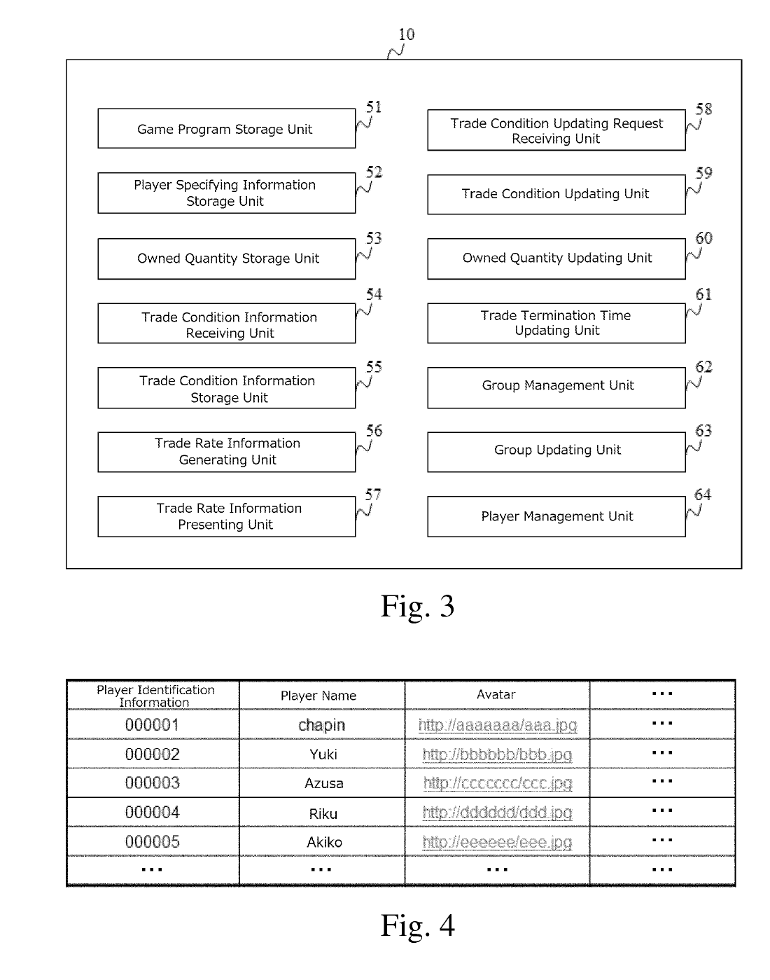

Next, the functionality of the server device 10 implemented by the components shown in FIG. 1 will be further described with reference to FIG. 3. FIG. 3 is a block diagram illustrating the functionality of a server device 10 according to an embodiment of the present invention. As shown in FIG. 3, the server device 10 according to the embodiment may comprise a game program storage unit 51, a player specifying information storage unit 52, an owned quantity storage unit 53, a trade condition information receiving unit 54, a trade condition information storage unit 55, a trade rate information generating unit 56, a trade rate information presenting unit 57, a trade condition updating request receiving unit 58, a trade condition updating unit 59, an owned quantity updating unit 60, a trade termination time updating unit 61, a group management unit 62, a group updating unit 63, and a player management unit 64.

As stated above, the game program storage unit 51 may store game programs for executing or operating various games executable or operable on the terminal device 30. A user of the terminal device 30 may obtain game programs stored on the game program storage unit 51 and runs the obtained game programs on the terminal device 30, thereby to play the game on the terminal device 30. As stated above, various games may be performed on the terminal device 30. The games performed on the terminal device 30 use various game media such as electronic cards, items, and virtual currency used in the games.

The term “game media” may collectively refer to electronic data used by players for progressing the games and including, for example, electronic cards, electronic items, avatars, and virtual currency. In an embodiment of the present invention, the game media may be obtained, owned, used, managed, exchanged, fused, reinforced, sold, discarded, and/or presented by players in the games in accordance with progression of the games; and the use of the game media is not limited to those explicitly described herein. In selling of a card in a game, a player is paid in virtual currency used in the game, not in real currency, for the card sold. A card used as a game medium may have parameters (e.g., “attribute,” “level,” “offensive power,” and “defensive power”) required for the progression of a game. These parameters may be updated as the game progresses. A player can progress the game using the card having updated parameters.

A player of a game stored on the game program storage unit 51 can obtain and own various game media such as items in accordance with the progression of the game. The items used in games may include, for example, weapon items that increase the offensive power of a character manipulated by a player, protector items that increase the defensive power, vehicle items that increase mobility, and restoration items that restore parameters such as “life” and “hit point”; but the items of the present invention are not limited to those explicitly disclosed herein.

For example, the player specifying information storage unit 52 may store, for each player, player specifying information that specifies the player. The “player specifying information” may consist of any information that represents personality and characteristics of a player and specify the player when presented to another player. In games, a display image representing a player may be generated based on the player specifying information, and the display image may be displayed in the game screen of another player to communicate the personality and the characteristics of the player to the other player. The display images representing the players may express the personalities of players, thereby encouraging interaction between players through the game.

The player specifying information may include, for example, player attribute information set by the player to characterize the player, such as a player name or avatar. The player name may be desirably determined by the player; therefore, a plurality of players possibly uses the same player name. Accordingly, a player name does not uniquely specify a player, but practically it serves as an indicator for specifying a player because the number of players interactively playing a game is limited in terms of time. Accordingly, a player name may be herein included in player specifying information that specifies a player. An avatar may also be included in player specifying information for the same reason. That is, many players may play games using avatars having distinctive appearance to express their personalities. To support such needs of players, various items for decorating avatars may be provided as a function of games or a platform of games. Accordingly, an avatar cannot always uniquely specify a player but practically serves for specifying a player.

The player specifying information storage unit 52 may generate and manage a player specifying information table illustrated in FIG. 4. The player specifying information table in FIG. 4 may manage various player specifying information such as player names and avatars in association with player identification information of each player. Avatars may be stored as, for example, images in JPEG format on the server device 10; the player specifying information management table may manage URLs indicating the location where the images are stored. The player specifying information may include various information occurring in progression of games, in addition to player attribute information desirably set by players such as user names and avatars. For example, the player specifying information may include player identification information that specifies a player.

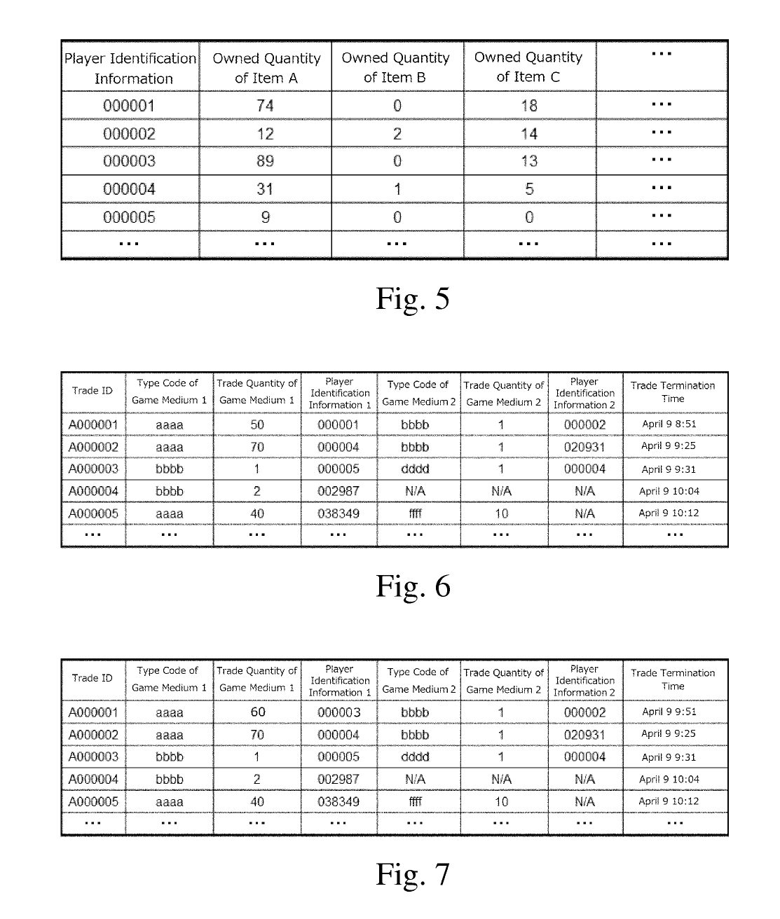

The owned quantity storage unit 53 may store the quantity of game media owned by players in association with player identification information of the players. FIG. 5 shows an example of owned quantity management table used in a game system according to an embodiment of the present invention. In this figure, the quantities of item A, item B, item C, . . . owned by each player are stored in association with the player identification information of the player. FIG. 5 is a mere example, and the owned quantity management table may store quantities of various game media such as cards and virtual currency, in addition to items. When a player newly obtains or consumes an item in accordance with the progression of the game, the owned quantity of the item may be updated in the owned quantity management table so as to reflect the activity in the game.

“Player identification information” may consist of an identification code that identifies a player of a game and may be composed of, for example, a six-digit number. The code system of the player identification information is not limited to those explicitly described herein and may be configured desirably. For example, the player identification information may include an alphabetic character. Ordinarily, the player identification information may be assigned to a player when the player first logs in a game, and may be reused for later logins of the player. Thus, the player identification information may be unique to a player and identifies the player in a game.

In the example shown in FIG. 5, the player identified by the player identification number “000001” (hereinafter “player 1”) owns 74 items A and 18 items C. Since player 1 does not own an item B, the field indicating the quantity of owned item B is set to “0.” Also, the player identified by the player identification number “000002” (hereinafter “player 2”) owns 12 items A, 2 items B, and 14 items C. The player identified by the player identification number “000003” (hereinafter “player 3”) owns 89 items A and 13 items C. The owned quantity management table shown in FIG. 5 is a mere example and is susceptible of various modifications. Further, the game medium identification information storage unit 52 is not necessarily required to store the owned quantity management table, but may store the quantities of items owned by each player in association with player identification information of the player, with a desired technique known to those skilled in the art. Players other than players 1 to 3 likewise own various game media; the quantities of game media owned by each player may be stored in association with player identification information of the player. Herein, the player identified by the player identification number “000004” in FIG. 5 is referred to as player 4, and the player identified by the player identification number “000005” is referred to as player 5.

Since game media such as items may be obtained as necessary by a player in accordance with the progression of the game, the owned quantity management table may be also updated in accordance with the progression of the game so as to reflect the change in the quantity owned by the player. For example, when the player obtains three items A, “3” may be added to the quantity of item A owned by the player; and when the player consumes one item B, “1” may be subtracted from the quantity of item B owned by the player.

When a player of a game makes a trade with another player to exchange game media, the trade condition information receiving unit 54 may receive, from the player, trade condition information that determines conditions of the trade. The trade condition information sent from one player may include, for example, the type and quantity of game media given to another player through the exchange, the player identification information of the one player, and the type and quantity of game media desirably to be obtained from the other player through the exchange. The items to be exchanged as game media may include, for example, rifle, shotgun, knife, bulletproof vest, coat, helmet, motorcycle, jeep, airplane, helicopter, restoration drink, and trap; but the types of items that can be exchanged in the present invention are not limited to these items.

The trade condition information storage unit 55 may store one or more sets of trade condition information received by the trade condition information receiving unit 54, in the trade condition information management table. FIG. 6 shows an example of trade condition information management table used in a game system according to an embodiment of the present invention. For example, when the trade condition information receiving unit 54 receives trade condition information from a player, the trade condition information storage unit 55 may generate a record for storing the trade condition information in the trade condition information management table. The record may be provided with “a trade ID” that identifies a trade based on the trade condition information; and the “trade ID” may be stored in the trade condition information management table in association with various information included in the trade condition information. The data stored in the trade condition information management table in association with a certain trade ID is herein referred to as “trade data” associated with the trade ID.

As shown in the figure, the trade condition information management table may include the columns of “Type Code of Game Medium 1,” “Trade Quantity of Game Medium 1,” and “Player Identification Information 1.” For convenience of description, part or all of “Type Code of Game Medium 1,” “Trade Quantity of Game Medium 1,” and “Player Identification Information 1” are herein also collectively referred to as “first trade condition information.” “Type Code of Game Medium 1” refers to the type of game media given from one player to another player. “Trade Quantity of Game Medium 1” refers to the quantity of game media specified by “Type Code of Game Medium 1” and given from one player to another player. “Player Identification Information 1” refers to the player identification information of the one player. “Type Code of Game Medium 1,” “Trade Quantity of Game Medium 1,” and “Player Identification Information 1” may be included in trade condition information received from the one player. Alternatively, in another embodiment, “Type Code of Game Medium 1,” “Trade Quantity of Game Medium 1,” and “Player Identification Information 1” may be generated in the server device 10 based on the trade condition information. Thus, “first trade condition information” may set the trade condition on which one player gives game media to another player.

Also, the trade condition information management table may include the columns of “Type Code of Game Medium 2,” “Trade Quantity of Game Medium 2,” and “Player Identification Information 2.” For convenience of description, part or all of “Type Code of Game Medium 2,” “Trade Quantity of Game Medium 2,” and “Player Identification Information 2” are herein also collectively referred to as “second trade condition information.” “Type Code of Game Medium 2” refers to the types of game media to be exchanged for the game media specified by “Type Code of Game Medium 1.” “Trade Quantity of Game Medium 2” refers to the quantity of game media specified by “Type Code of Game Medium 2” and given to the one player in exchange for the game media specified by “Type Code of Game Medium 1.” “Player Identification Information 2” refers to the player identification information of the other player who gives the game media specified by “Type Code of Game Medium 2” to the one player. Thus, “second trade condition information” may set the trade condition on which the other player gives game media to the one player in exchange for the game media specified by “Type Code of Game Medium 1.” “Trade data” identified by a certain trade ID may include “first trade condition information” indicating trade conditions for game media of the one player and “second trade condition information” indicating trade conditions for game media to be exchanged for the game media; and therefore, “trade data” may determine the trade rate between these game media.

As will be described later, each of “Type Code of Game Medium 1,” “Trade Quantity of Game Medium 1,” “Player Identification Information 1,” “Type Code of Game Medium 2,” “Trade Quantity of Game Medium 2,” and “Player Identification Information 2” may be updated as required based on the trade condition information or trade condition updating request sent from a player of the game to the server device 10.

The trade condition information management table may further contain “trade termination time” for each trade ID. “Trade termination time” may indicate the time when the exchange of items identified by the trade ID is terminated. For example, “trade termination time” may be the time one hour later than a reference time when the trade ID is generated. By way of an example, if a trade ID is generated at 7:51 am on April 9, “trade termination time” may be 8:51 am on April 9, which is one hour thereafter. As will be described later, a trade rate between items may be determined based on a trade record stored in the trade condition information management table at the time when the trade is terminated. As will be described later, the trade termination time may be updated when other data stored in the trade condition information management table is updated.

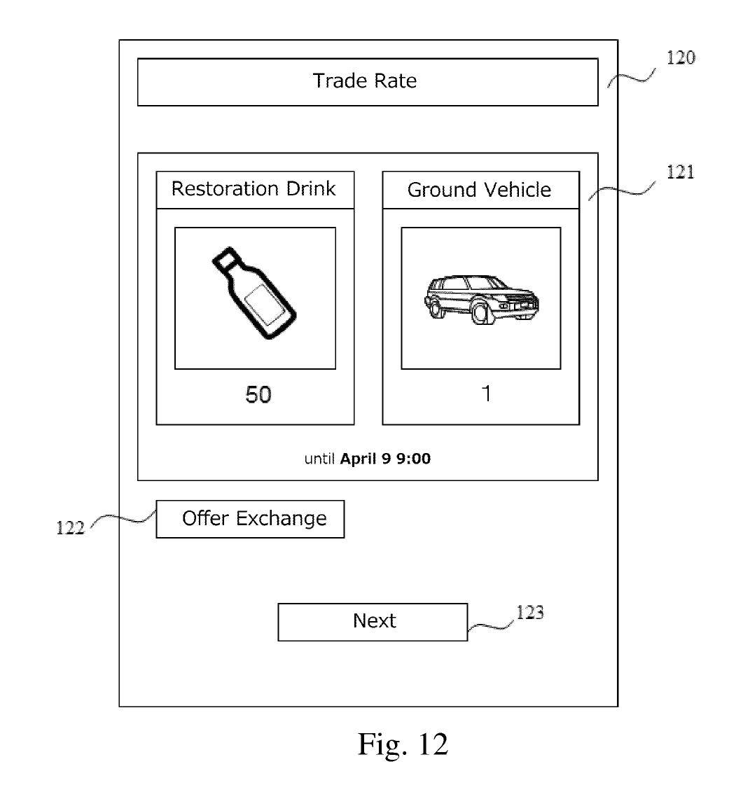

The trade termination time may be provided to a game while being included in trade rate information, which will be described later. When the trade termination time is included in the trade rate information, the trade termination time may be displayed in a display screen of the terminal device 30. When the trade ID is generated immediately after a player sends the trade condition information, the player can substantially freely set the trade termination time by adjusting the timing of sending the trade condition information. Therefore, if the player informs another player of this trade termination time through email or other means outside the game, the other player possibly can specify the player who has set the trade condition information (that is, the player who has set the trade termination time). To overcome this problem, the trade termination time read out from the trade condition information management table can be altered by rounding; the altered trade termination time is included in the trade rate information to prevent the player from being specified based on the displayed trade termination time. For example, the trade ID “A000001” in FIG. 6 has a trade termination time set to “April 9 8:51.” If the trade termination time “April 9 8:51” is displayed unchanged, such trade termination time is communicated to the other player, and the player concerned in the trade corresponding to this trade ID can be specified. If the trade termination time is altered to a rounded time, for example, “April 9 9:00,” the player concerned in the trade can be prevented from being specified based on the trade termination time (see FIG. 12). In another embodiment, the trade rate information may not include the trade termination time so that the trade termination time is not informed to players.

In the example shown in FIG. 6, the trade condition information management table may store “Type Code of Game Medium 1” set to an item type code “bbbb” representing item B, “Trade Quantity of Game Medium 1” set to “2,” and “Player Identification Information 1” set to “002987,” in association with a trade ID “A000004.” The trade record with the trade ID “A000004” may be generated when, for example, trade condition information is received from the player identified by the player identification information “002987,” the trade condition information including the item type code “bbbb” identifying item B, information specifying the quantity “2” of item B, and the player identifying information “002987.” The first trade condition information may be generated at the terminal device 30 of the player of the player identification information “002987” and sent to the server device 10 when the player desires to provide another player with two items B and obtain other items from the other player. If the trade condition information does not include information that specifies game media desirably to be obtained from the other player, no information may be stored in the fields of “Type Code of Game Medium 2,” “Trade Quantity of Game Medium 2,” and “Player Identification Information 2,” as shown in the record with a trade ID “A000004” in FIG. 6.

Further, in the example shown in FIG. 6, the record with a trade ID “A000005” has “Type Code of Game Medium 1” set to an item type code “aaaa,” “Trade Quantity of Game Medium 1” set to “40,” “Player Identification Information 1” set to “038349,” “Type Code of Game Medium 2” set to an item type code “ffff,” and “Trade Quantity of Game Medium 2” set to “10.” The trade record with the trade ID “A000005” may be generated when the player of the player identification information “038349” wants to obtain 10 items F in exchange for 40 items A, and trade condition information based on such trade condition is received from the player. Although the record with the trade ID “A000005” does not contain any information in the field “Player Identification Information 2,” the filed may be filled with player identification information of another player when trade condition information related to the trade ID “A00005” and specifying the quantity of item F identified by the item type code “ffff” is received from the other player.

Further, the record with a trade ID “A000001” in FIG. 6 shows an example where trade condition information or a trade condition updating request is received from another player. As shown, the record with a trade ID “A000001” has “Type Code of Game Medium 1” set to an item type code “aaaa,” “Trade Quantity of Game Medium 1” set to “50,” “Player Identification Information 1” set to “000001,” “Type Code of Game Medium 2” set to an item type code “bbbb,” “Trade Quantity of Game Medium 2” set to “1,” and “Player Identification Information 2” set to “000002.” This record may be generated when, for example, the player of player identification information “000001” wants to exchange his own 50 items A for item B owned by another player, and the player identified by the player identification information “000002” responds to this desired exchange and offers trade condition of providing one item B.

As will be described later, part of data stored in the trade condition information management table may be presented to other players through play screens of the game. For example, part of the information included in the record with a trade ID “A000001” may be presented to players of the game through the game; therefore, the players come to know that a condition for exchanging 50 items A for one item B is offered. The players can send, to the server device 10, a trade condition updating request specifying a condition more advantageous than that already offered; and the server device 10 can update the trade condition information management table based on the trade condition updating request. The updating of the trade condition information management table will be described in detail later.

In response to, for example, a search request from a player, the trade rate information generating unit 56 may generate, for each trade ID stored in the trade condition information management table, trade rate information including the trade quantity of game medium 1 and the trade quantity of game medium 2 associated with the trade ID. As will be described later, the generated trade rate information may be displayed in a display screen on the terminal device 30 as part of a game screen when the game is played on the terminal device 30. A player views the trade rate information displayed on the terminal device and comes to know the trade rate at which a game medium is exchanged.

In an embodiment, the trade rate information may be generated not to include player specifying information. The trade condition information management table shown in FIG. 6 may store player identification information of players who wants to make a trade. In an embodiment, the trade rate information generating unit 56 may also generate trade rate information that does not include player identification information or other player specifying information (e.g., a player name or avatar) obtained by referring to, for example, a player specifying information table in association with the player identification information. Thus, the trade rate information may include information that specifies the exchange rate of the item to be exchanged but does not include information that specifies the player who has set the exchange rate. For example, when trade rate information is generated based on the trade record with a trade ID “A000001,” an exchange rate of 50 items A to one item B can be determined based on the trade rate information; the generated trade rate information does not include player specifying information that specifies the player of the player identification information “000001” who has set the exchange condition related to item A, or player specifying information that specifies the player of the player identification information “000002” who has set the exchange condition related to item B.

In an embodiment, the trade rate information generating unit 56 can alter the data read out from the trade condition information management table and generate trade rate information including the altered data. For example, trade quantity of game media, which can be freely inputted by a player, can be possibly set to unnatural information of trade quantity; and if this information is communicated to another player through email or other means outside the game, the player who inputted the information may be specified by the other player. For example, if a player inputs an unnatural trade quantity such as “131” for a certain item and communicates the quantity “131” to another player, the other player may identify the player who inputted the information from other players with a sign of the trade quantity “131.” To overcome this problem, in an embodiment of the present invention, the trade rate information generating unit 56 may alter the input information freely inputted by the player by rounding and generate trade rate information by using the altered information. This prevents information that can be freely inputted by a player from serving as a sign. For example, if trade quantity is set to “131,” it can be rounded to “150” by 50-increment rounding or to “100” by 100-increment rounding. When the trade quantity is rounded by “50”—increment rounding, it may be displayed to be “150” instead of “131” when the trade rate information is displayed on the terminal device 30; thus, the trade quantity is prevented from serving as a sign.

In response to a request from a player, the trade rate information presenting unit 56 may present, to the player, trade rate information generated by the trade rate information generating unit 56. The player playing a game can send a display request for trade rate information to the server device 10, through operation of the terminal device 30 performing the game. The trade rate information presenting unit 56 can send trade rate information to the game performed on the terminal device 30 which has sent the display request. The terminal device 30 can display a trade rate display screen generated from the trade rate information as, for example, part of a display screen of the game.

A player can send a trade condition updating request from the terminal device 30 to the server device 10, thereby to offer more advantageous trade condition than the trade rate displayed in the trade rate display screen. The trade condition updating request may be received by a trade condition updating request receiving unit 58 of the server device 10. When the trade condition updating request is received by the trade condition updating request receiving unit 58 prior to the trade termination time, the trade condition updating unit 59 may compare the trade quantity of the game media associated with the trade ID specified by the trade condition updating request, with the trade quantity of the game media included in the trade condition updating request. If the trade quantity included in the trade information updating request is greater than the quantity stored in the trade condition information management table at the time when the trade information updating request is received, the trade condition updating unit 59 may update the fields of “Trade Quantity of Game Medium 1” and “Player Identification Information 1” of the trade condition information table so as to include the trade quantity included in the trade condition updating request and the player identification information of the player who has sent the trade condition updating request.

For example, the record with a trade ID “A000001” in FIG. 6 may store an exchange rate of 50 items A to one item B. The player identified by the player identification information “000003” may generate a trade condition updating request including the trade ID “A000001,” item type information “aaaa” specifying item A, and a trade quantity “60” of item A, and send the trade condition updating request to the server device 10. The trade condition updating request may be received by a trade condition updating request receiving unit 58. When the trade condition updating request is received prior to the trade termination time, the trade condition updating unit 59 may compare the trade quantity of item A associated with the trade ID “A000001” included in the trade condition updating request (i.e., “50” in FIG. 6), with the trade quantity “60” of items A included in the trade condition updating request. In this case, since the trade quantity of item A included in the trade condition updating request is greater, the trade condition updating unit 59 may update the fields of “Trade Quantity of Game Medium 1” and “Player Identification Information 1” in the trade condition information management table associated with the trade ID “A000001” so as to include the trade quantity “60” included in the trade condition updating request and the player identification information “000003” of the player who has sent the trade condition updating request.

As stated above, the trade condition stored in the trade condition information management table can be updated based on the trade condition updating request. FIG. 7 shows an example of updated trade condition information management table. In the example shown in FIG. 7, the record of trade ID “A000001” has “Trade Quantity of Game Medium 1” set to “60” instead of “50” originally stored and “Player Identification Information 1” set to “000003” instead of “000001” originally stored. Thus, the first trade condition information and/or the second trade condition information stored in the trade condition information management table can be updated when a better trade rate is offered by the trade condition updating request.

The trade termination time updating unit 61 may update trade termination time set for each trade ID based on a trade condition updating request. For example, the trade termination time updating unit 61 may update the trade termination time stored in the trade condition information management table for a certain trade ID based on the time when a trade condition updating request related to the trade ID is received by the trade condition updating request receiving unit 58. For example, in the example shown in FIG. 6, the record of trade ID “A000001” has trade termination time set to “April 9 8:51.” If a trade condition updating request related to the trade ID “A000001” is received prior to this trade termination time, the originally stored trade termination time may be replaced with, for example, “April 9 9:51,” that is, one hour later than the originally stored trade termination time. In the example of an updated trade condition information management table shown in FIG. 7, the record of trade ID “A000001” has “Trade Termination Time” set to “April 9 9:51” after updating.

The trade rate set for each trade ID in the trade condition information management table may be concluded at the trade termination time associated with the trade ID. When the trade termination ID is updated, the trade rate may be concluded at the updated trade termination time. More specifically, a trade condition may be concluded between the player identified by the player identification information stored in “Player Identification Information 1” (hereinafter referred to as “first player” for convenience) and the player identified by the player identification information stored in “Player Identification Information 2” (hereinafter referred to as “second player” for convenience) as follows: the first player gives the second player game media stored in “Type Code of Game Medium 1” (hereinafter referred to as “first game media” for convenience) in the quantity stored in “Trade Quantity of Game Medium 1,” and in exchange, the second player gives the first player game media stored in “Type Code of Game Medium 2” (hereinafter referred to as “second game media” for convenience) in the quantity stored in “Trade Quantity of Game Medium 2.” That is, a trade may be concluded in the game to exchange the first game media and the second game media between the first player and the second player at a trade rate determined by the trade quantity of game media 1 and the trade quantity of game media 2.

For example, in the example shown in FIG. 7, when the trade termination time “April 9 9:51” associated with the trade ID “A000001” is reached, a trade may be concluded wherein player 3 of player identification information “000003” gives 60 items A to player 2 of the player identification information “000002” and receives one item B in exchange,

When a trade termination time for a record specified by a certain trade ID is reached, the owned quantity updating unit 60 may update the owned quantities of first game media and the second game media stored in the owned quantity management table based on the first trade condition information and the second trade condition information stored in the trade condition information management table at the trade termination time. For example, in accordance with the trade record specified by the trade ID “A000001” in FIG. 7, the owned quantity updating unit 60 may subtract, at the trade termination time, the trade quantity “60” included in the first trade condition information from the owned quantity “89” of items A (the first game media) associated with the player identification information of player 3 in the owned quantity management table, and add, at the trade termination time, the trade quantity “1” included in the second trade condition information to the owned quantity of item B (the second game media) associated with the player identification information of player 3 in the owned quantity management table. Also, the owned quantity updating unit 60 may subtract, at the trade termination time, the trade quantity “1” included in the second trade condition information from the owned quantity of item B associated with the player identification information of player 2 in the owned quantity management table, and add, at the trade termination time, the trade quantity “60” included in the first trade condition information to the owned quantity of item A associated with the player identification information of player 2 in the owned quantity management table.

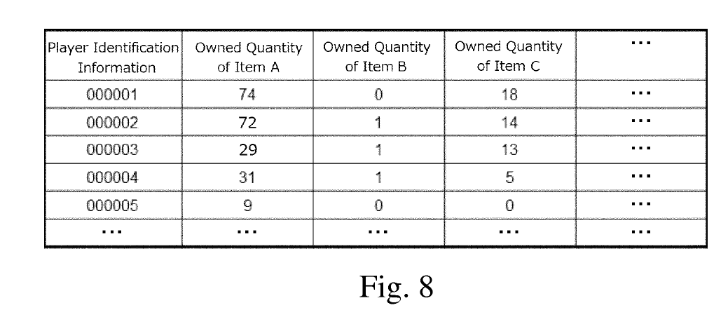

The owned quantity management table thus updated is shown in FIG. 8. As shown in FIG. 8, the quantity of item A owned by player 2 is increased from “12” before the exchange to “72” by 60, while the quantity of item B owned by player 2 is decreased from “2” before exchange to “1” by 1. Meanwhile, the quantity of item A owned by player 3 is decreased from “89” before the exchange to “29” by 60, while the quantity of item B owned by player 3 is increased from “0” before exchange to “1” by 1. Thus, if a trade is concluded between player 2 and player 3 wherein player 2 gives one item B to player 3, and in exchange, player 3 gives 60 items A to player 2, the exchange may be reflected on the owned quantities stored in the owned quantity management table.

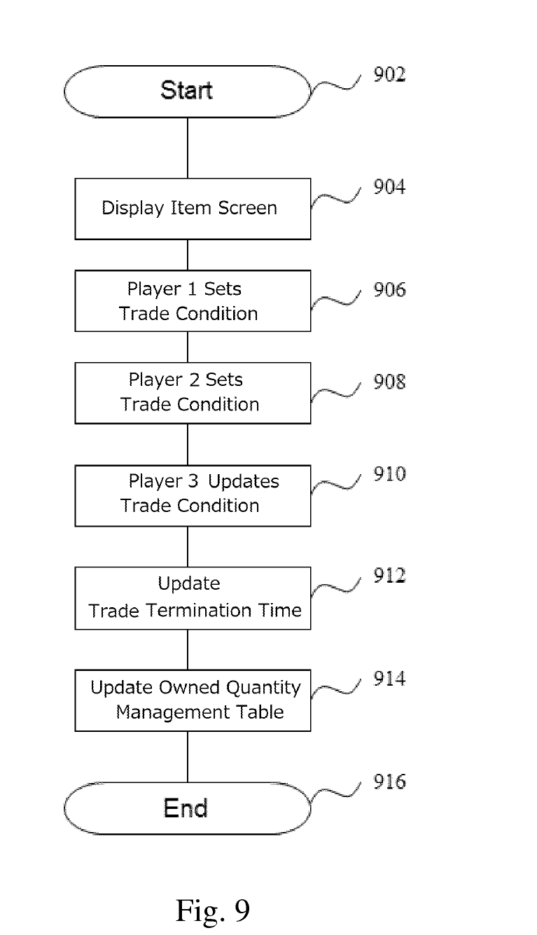

Next, the processing of exchanging game media in a game system configured as stated above will be further described with reference to FIG. 9. FIG. 9 is a flowchart showing an example of processing of exchanging an item termed “restoration drink” and an item termed “ground vehicle” in a game by using a game system according to an embodiment of the present invention. The “restoration drink” and “ground vehicle” are mere examples of game media, and other desired game media may be traded in the present invention in accordance with the processing shown in FIG. 9. Additionally, FIG. 9 shows an example wherein game media are exchanged between player 1, player 2, and player 3; but a desired number of players can trade game media in accordance with the processing shown in FIG. 9.

First, the processing of exchanging game media is started in step 902. In this step, player 1 may operate his own terminal device 30 to obtain a desired game program from the server device 10 and run the game program on the terminal device 30. Next, in step 904, player 1 may show an item owned by player 1 in the game on the screen of the terminal device 30 in accordance with an instruction from the game program. For example, a main screen of the performed game displayed on the terminal device 30 may contain links or operation buttons captioned “Items,” “Treasures,” or “Belongings.” Player 1 can operate these links or operation buttons to show part or all of items owned by player 1.

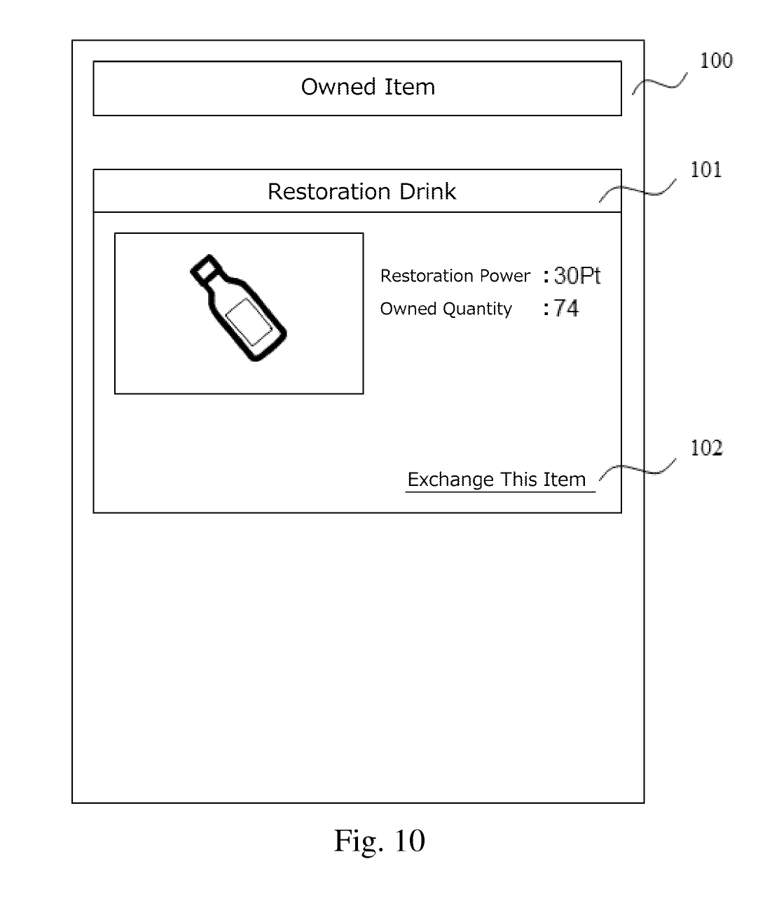

FIG. 10 shows an example of an item displayed in a game system according to an embodiment of the present invention. For example, when player 1 operates an icon whose caption includes “Belongings,” the display screen 100 shown in FIG. 10 may be displayed on the terminal device 30 of player 1. As shown in the owned quantity management table in FIG. 5, player 1 has 74 items A; and thus a display image 101 representing the item of “restoration drink” corresponding to item A may be displayed on the terminal device of player 1. The display image 101 may include the name of the item “Restoration Drink,” an image representing the item, parameters of the item (restoration power 30 Pt), the owned quantity of the item (74), and a link 102 to the setting screen of the trade conditions for the item. The display image 101 may include various information other than that illustrated in FIG. 10.

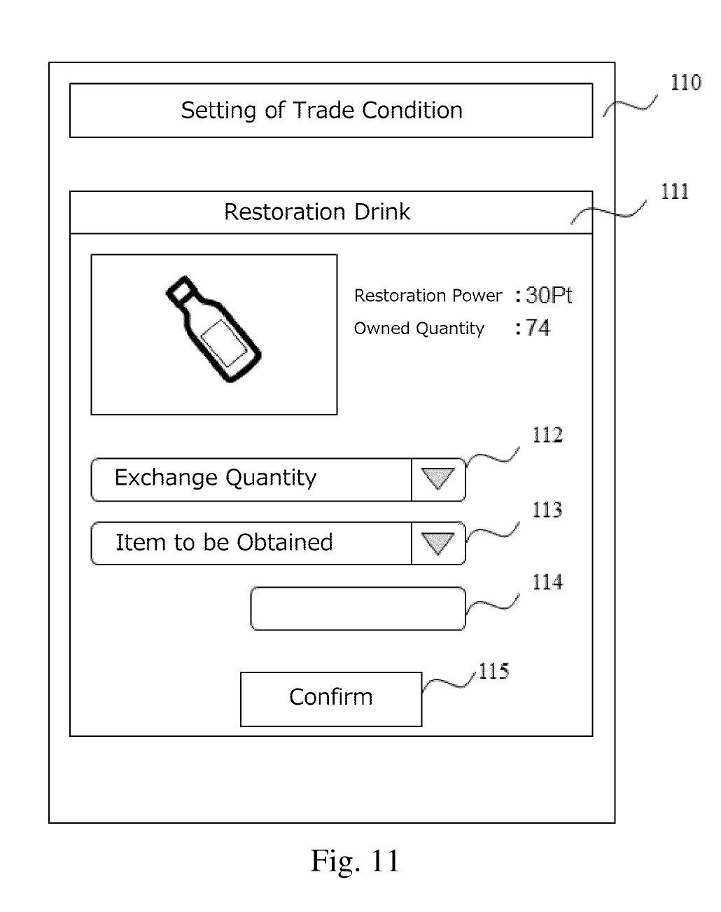

When player 1 selects the link 102, the process proceeds to step 906 where a trade condition setting screen 110 for setting trade conditions for the item as illustrated in FIG. 11 may be displayed on the terminal device 30 of player 1. As shown, the trade condition setting screen 110 may include a setting image 111 for setting trade conditions for “Restoration Drink” to be provided from player 1 to another player. The setting image 111 may include a pulldown box 112 for designating the quantity (trade quantity) of “Restoration Drink” provided from player 1 to the other player, a pulldown box 113 for designating the type of the item desirably to be obtained from the other player in exchange for “Restoration Drink,” an input box 114 for designating the quantity of the item, and a confirmation button 115 for confirming the designated trade conditions. The pulldown box 112 may provide a limited number of options (e.g., 10-increment options ranging from 10 to 200 such as “10,” “20,” and “200”) indicating the quantity of the item to be provided to the other player; and player 1 may select from the options a value equal to or smaller than the quantity of his own item A such as “50.” The pulldown box 113 may provide a plurality of options indicating the types of the item. For example, the pulldown box 113 may provide options such as “shotgun,” “bulletproof vest,” “ground vehicle,” and “helicopter”; and player 1 may select, for example, “ground vehicle” from the options. Then, player 1 may input, for example, “1” into the input box 114 for the quantity of “ground vehicle.” After inputting all the trade conditions, player 1 may select the confirmation button 115 to confirm the trade conditions to be informed to the server device 10.

As stated above, the trade quantity inputted into the input box 114 may be altered by the trade rate information generating unit 56 to prevent the trade quantity from serving as a sign. In this case, a screen (not shown in FIG. 11) that requires the player to confirm the alteration of the trade quantity may be displayed; and only if an operation button included in the display screen is selected by the player, the confirmation button 115 may be activated; thus, the alteration (rounding) of the trade quantity can be previously agreed by the player.

In an embodiment, the input box 114 may be configured to provide a limited number of options (e.g., 10-increment options ranging from 10 to 200 such as “10,” “20,” and “200”), as is the pulldown box 112. Thus, the player is not allowed to input freely and is forced to select trade quantity from the limited number of preset options, so that the trade quantity is prevented from serving as a sign as in the above case where the trade quantity is rounded.

When the confirmation button 115 is selected, trade condition information may be sent to the server device 10, the trade condition information including the item type code “aaaa” that specifies “restoration drink” provided by player 1, the quantity “50” of “restoration drink,” the game medium type code “bbbb” that specifies “ground vehicle” wanted by player 1, the quantity “1” of “ground vehicle,” and the player identification information “000001” of player 1. The server device 10 may receive the received trade condition information via the trade condition information receiving unit 54. Subsequently, the trade condition information storage unit 55 may generate a trade ID “A000001” for specifying the trade related to the trade condition information; and the trade ID “A00001” and the various information included in the trade condition information may be stored into the trade condition information management table in association with each other. More specifically, the first trade condition information including the item type code “aaaa” that specifies “restoration drink,” the quantity “50” of the “restoration drink,” and the player identification information “00001” of player 1 may be stored in association with the trade ID “A000001.” Additionally, the second trade condition information including the game medium type code “bbbb” that specifies “ground vehicle” wanted by player 1 and the quantity “1” thereof may be stored in association with the trade ID “A000001.” Immediately after the trade ID “A000001” is generated, no player has made an offer of exchange; therefore, player identification information 2 may contain no information.

Subsequently, in step 908, player 2 may set the trade condition information. When playing the same or similar game as player 1 on the terminal device 30, player 2 can use the search function provided by the game to retrieve, from the trade condition information management table, information in the trade record where “restoration drink” is to be exchanged. For example, based on the search request from the player, the trade rate information generating unit 56 may specify the trade ID “A000001” where “restoration drink” is to be exchanged, and generate trade rate information including the trade quantity of “restoration drink” and the trade quantity of “ground vehicle” associated with the trade ID “A000001.” The generated trade rate information may be provided to the game performed on the terminal device 30 which has sent the search request. The trade rate information may include the trade ID “A000001.” The terminal device 30 may generate a display screen of trade rate information (trade rate screen) based on the trade rate information, and display the generated trade rate screen in the display screen as part of the game screen.

FIG. 12 shows an example of a trade rate screen 120 for displaying trade rate information in a game system according to an embodiment of the present invention. As shown, the trade rate screen 120 may include exchange item display image 121 including an image representing “restoration drink” and the characters “50” indicating the trade quantity thereof, and an image representing “ground vehicle” and the character “1” indicating the trade quantity thereof associated with the trade ID “A000001.” Player 2 views this trade rate screen 120 and comes to know the trade rate for exchanging 50 “restoration drinks” for one “ground vehicle.” Meanwhile, as described above, the trade rate information does not include player specifying information that specifies the player; therefore, player 2 viewing the trade rate screen 120 cannot specify the player who has made the trade condition information related to the trade rate. The trade condition information management table shown in FIG. 6 may also store trade condition information of trade IDs “A000002” and “A000005” in which “restoration drink” is to be exchanged. Accordingly, the game performed on the terminal device 30 of player 2 may also be provided with trade rate information generated based on the trade IDs “A000002” and “A000005.” Player 2 can select an operation button 123 located in the lower part of the display screen 120 and captioned “Next” to show a trade rate screen on the terminal device 30, the trade rate screen displaying trade rate information generated based on the trade ID “A000002” and/or the trade ID “A000005.”

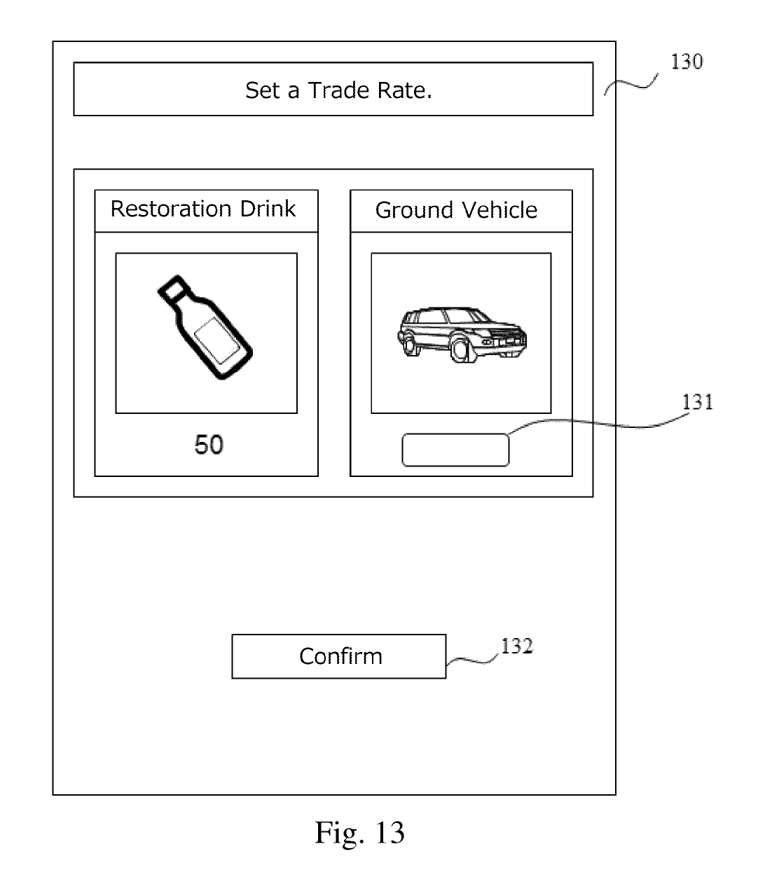

The display screen 120 may display an operation button 122 captioned “Offer Exchange” below the image representing “restoration drink.” When player 2 selects the operation button 122, the display screen on the terminal device 30 of player 2 may transition to a trade rate setting screen 130 for setting a trade rate, as shown in FIG. 13. The trade rate setting screen 130 shown in FIG. 13 may include an input box 131. Player 2 can input into the input box 131 the trade quantity of “ground vehicle” to be provided to the partner of the exchange to obtain 50 “restoration drinks.” Supposing that player 2 inputs “1” into the input box 131 and selects the confirmation button 132, trade condition information may be sent to the server device 10, the trade condition information including the trade ID “A000001,” the game medium type code “bbbb” that specifies “ground vehicle,” the quantity “1” of the “ground vehicle,” and the player identification information “000002” of player 2.

The trade condition information sent from player 2 may be received by the trade condition information receiving unit 54. Next, the trade condition information storage unit 55 may store the quantity “1” of the “ground vehicle” and the player identification information “000002” of player 2 included in the trade condition information as second trade condition information in association with the trade ID “A000001” included in the received trade condition information.

Next, in step 910, player 3 who desires to obtain the “ground vehicle” may input trade condition information. Player 3 may search the trade condition information management table for records in which “ground vehicle” is to be exchanged, in the same manner as have already been described for player 2. Based on the search result, trade rate information may be generated as described above; and the generated trade rate information may be presented to the game played by player 3. The terminal device 30 of player 3 may generate a display screen of trade rate information (trade rate screen) based on the trade rate information, and display the generated trade rate screen in the display screen as part of the game screen. The trade rate screen displayed on the terminal device 30 of player 3 may be the same as the screen shown in FIG. 12, except that “Offer Exchange” button is located below the image of “ground vehicle,” not below the image of “restoration drink.”

Next, when player 3 selects “Offer Exchange” button, a trade rate setting screen may be displayed on the terminal device 30. The trade rate setting screen may be the same as the trade rate setting screen 130 shown in FIG. 13, except that the input box for inputting the trade quantity of the item to be provided to an exchange partner may be displayed below the image of “restoration drink,” not below the image of “ground vehicle.” Player 3 may input the quantity “60” of the “restoration drink” into the input box displayed below the “restoration drink” in the trade rate setting screen. Next, player 3 may select the same confirmation button as the confirmation button 132, and trade condition updating request may be sent to the server device 10, the trade condition updating request including the trade ID “A000001,” the game medium type code “aaaa” that specifies the “restoration drink,” the quantity “60” of the “restoration drink” inputted by player 3, and the player identification information “000003” of player 3.

The trade condition updating request sent from player 3 may be received by the trade condition updating request receiving unit 58. If the trade condition updating request is received prior to the trade termination time (April 9 9:00) for the trade ID “A000001,” the trade condition updating unit 59 may compare the quantity “50” of the “restoration drink” associated with the trade ID “A000001” in the trade condition information management table and the quantity “60” of the “restoration drink” included in the trade condition updating request. In this case, the quantity of the “restoration drink” included in the trade condition updating request is greater than the quantity held in the trade condition information management table; therefore, the trade condition information management table may be updated such that the first trade condition information associated with the trade ID “A000001” includes the quantity “60” of the “restoration drink” included in the trade condition updating request and the player identification information “000003” of player 3. More specifically, as shown in FIG. 7, “Trade Quantity of Game Medium 1” associated with the trade ID “A000001” may be updated from “50” to “60,” and “Player Identification Information 1” may be updated from “000001” to “000003.” Supposing that player 3 inputs “40” for the trade quantity of “restoration drink,” the trade quantity of the “restoration drink” inputted by player 3 is smaller than the trade quantity of the “restoration drink” stored in the trade condition information management table; therefore, the trade condition information management table may not be updated.

Next, in step 912, in response to the updating operation of the first trade condition information associated with the trade ID “A000001,” the trade termination time updating unit 61 may postpone the trade termination time associated with the trade ID “A000001” by, for example, one hour.

Next, in step 914, the owned quantity updating unit 60 may update, at the trade termination time associated with the trade ID “A000001,” the owned quantity of the game media stored in the owned quantity management table, based on the first trade condition information and the second trade condition information stored in the trade condition information management table in association with the trade ID “A000001.” If the trade termination time is reached after the trade condition updating request is received from player 3 and the trade record of the trade ID “A000001” is updated as shown in FIG. 7, the trade rate may be concluded based on the first trade condition information (i.e., the information stored in “Type of Game Medium 1,” “Trade Quantity of Game Medium 1,” and “Player Identification Information 1”) and the second trade condition information (i.e., the information stored in “Type of Game Medium 2,” “Trade Quantity of Game Medium 2,” and “Player Identification Information 2”) in the trade record associated with the trade ID “A000001” shown in FIG. 7. The owned quantity of the game media stored in the owned quantity management table may be updated based on the first trade condition information and the second trade condition information. In FIG. 7, “Player Identification Information 1” stores “000003” that identifies player 3, and “Player Identification Information 2” stores “000002” that identifies player 2; therefore, “Owned Quantity of Item A” and “Owned Quantity of Item B” in the owned quantity management table shown in FIG. 5 associated with each of “000003” and “000002” may be updated based on “Trade Quantity of Game Medium 1” and “Trade Quantity of Game Medium 2” in FIG. 7. That is, “60” stored in “Trade Quantity of Game Medium 1” may be subtracted from the owned quantity “89” of item A (“restoration drink”) associated with “000003” in the owned quantity management table; and “1” stored in “Trade Quantity of Game Medium 2” may be added to the owned quantity “0” of item B (“ground vehicle”). Simultaneously, “60” stored in “Trade Quantity of Game Medium 1” may be added to the owned quantity “12” of item A (“restoration drink”) associated with “000002” in the owned quantity management table and “1” stored in “Trade Quantity of Game Medium 2” may be subtracted from the owned quantity “2” of item B (“ground vehicle”).

Thus, the owned quantities of item A and item B may be updated; as a result, the updated owned quantity management table may be as shown in FIG. 8. After this updating operation, player 2 can play the game using 72 “restoration drinks” and one “ground vehicle,” and player 3 can play the game using 29 “restoration drinks” and one “ground vehicle.” As for player 1, since the trade for obtaining “ground vehicle” is not concluded, the owned quantity of “ground vehicle” remains “0.” As described above, game media may be exchanged between players based on the trade conditions inputted by the players.

If a trade condition updating request sent from a player other than player 3 to the server device 10 is received prior to the trade termination time, the trade condition information table may be further updated based on this request. This is not shown in FIG. 9. For example, player 4, who desires to obtain “restoration drink,” may search the trade condition information management table for records in which “restoration drink” is to be exchanged, by using a search function provided by the game. Based on the search result, trade rate information including the trade quantity of “restoration drink” and the trade quantity of “ground vehicle” may be generated in the same manner as have already been described for player 3, and the generated trade rate information may be presented in the game of player 4.

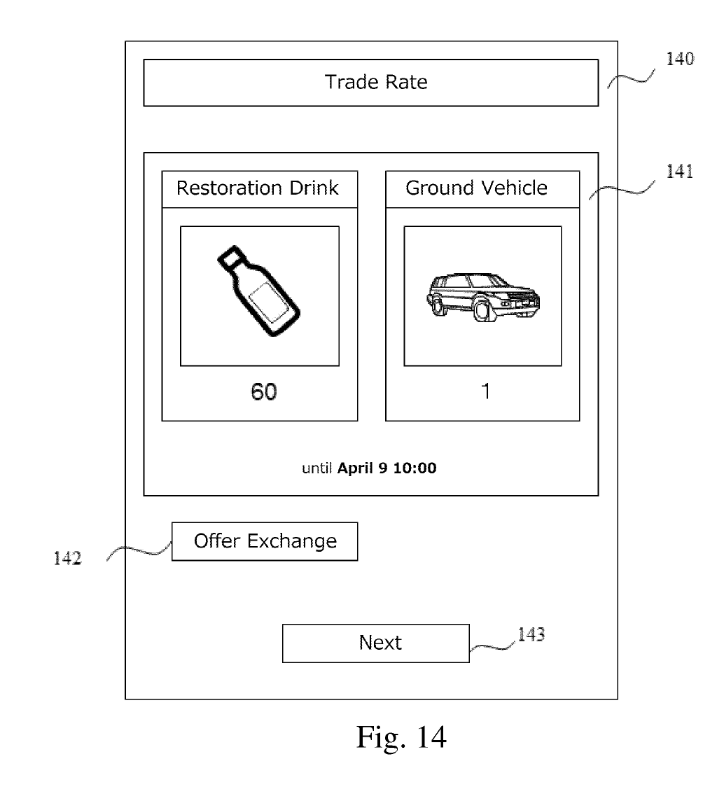

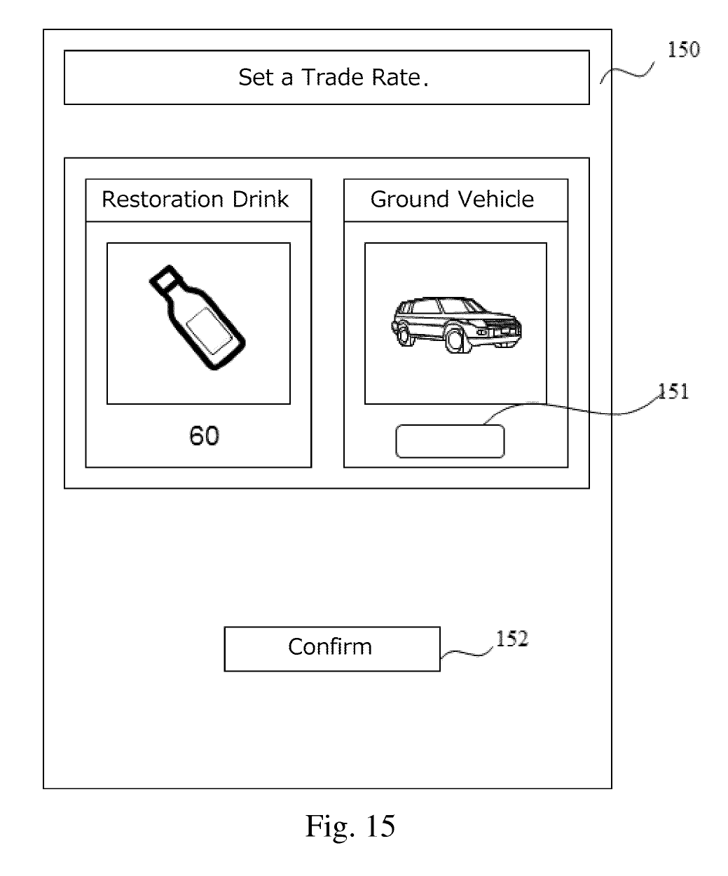

FIG. 14 shows an example of trade rate screen thus presented to the game; and FIG. 15 shows an example of a trade rate setting screen for setting a trade rate that can be reached from the trade rate screen shown in FIG. 14. FIG. 14 shows, by way of an example, a trade rate screen 140 in the case where the trade condition information management table is updated as shown in FIG. 7 based on the trade condition updating request from player 3. In the trade condition information management table in FIG. 7, “Trade Quantity of Game Medium 1” representing the trade quantity of “restoration drink” has been updated to “60”; therefore, the exchange item display image 141 may contain the quantity of “restoration drink” being “60.” When player 4 selects the operation button 142 on the trade rate screen 140 shown in FIG. 14, the display screen of the terminal device 30 may transition to the trade rate setting screen 150 shown in FIG. 15. In the trade rate setting screen 150, player 4 may input a trade quantity of “ground vehicle” into the input box 151.

When the confirmation button 152 is operated, a trade condition updating request including the trade quantity of “ground vehicle” inputted by player 4 and the player identification information of player 4 may be sent to the server device 10. The server device 10 may process the trade condition updating request from player 4 in the same manner as the trade condition updating request received from player 3 and update the trade termination time and the owned quantity management table. Further, FIGS. 14 and 15 shows examples of trade rate screen and trade rate setting screen displayed when player 4 searches for trade data in which “restoration drink” is to be exchanged to obtain “restoration drink” in exchange for “ground vehicle.” Player 4 can also search for trade data in which “ground vehicle” is to be exchanged to obtain “ground vehicle,” as can player 3. In this case, a display screen may be provided to player 4 to receive input for providing “ground vehicle,” as is provided to player 3.

As described above, in an embodiment of the present invention, when trade rate information is generated to present, to another player, a trade rate for exchanging game media between players, the generated trade rate information does not include player specifying information that specifies the player who inputted the trade condition that determines the trade rate. Thus, in the sequential process of exchanging game media in a game, a player cannot specify the player who inputted the trade condition. Accordingly, even if players agree outside the game on payment of real currency in expense of exchanged game media, the partner of such a trade outside the game cannot be specified in the game. Thus, if a function of preventing a partner of exchange of game media from being specified is implemented in a game, the function inhibits trading in reality. Accordingly, a game system according to an embodiment of the present invention technically restrains real money trade.

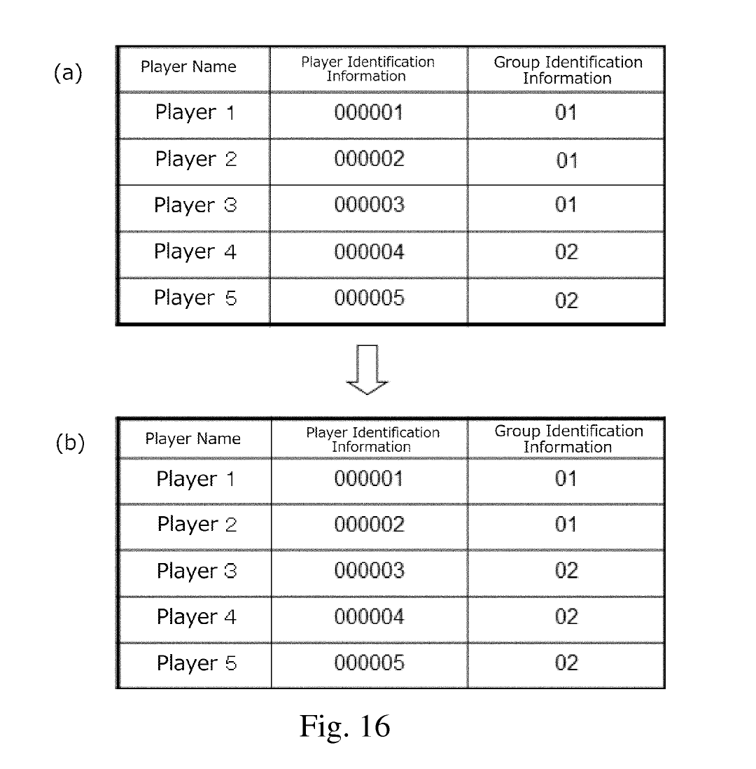

In another embodiment of the present invention, the server device 10 may further comprise a group management unit 62. The group management unit 62 may randomly group players of a game into a plurality of groups. For example, the group management unit 62 may manage groups of players with a group management table as shown in FIGS. 16(a) and 16(b). FIGS. 16(a) and 16(b) shows an example of group management table for managing groups of players of a game. In FIG. 16(a), player 1, player 2, and player 3 are grouped in the first group represented by the group identification information “01,” while player 4 and player 5 are grouped in the second group represented by the group identification information “02.”

The group updating unit 63 may regularly or irregularly alter the grouping of the players in accordance with a certain algorithm. FIG. 16(b) shows an example of the group management table after the grouping is altered. In FIG. 16(b), player 1 and player 2 are grouped in the first group represented by the group identification information “01,” while player 3, player 4, and player 5 are grouped in the second group represented by the group identification information “02.”

In the embodiment, the trade rate information presenting unit 56 may present trade rate information generated with respect to trade data associated with a certain trade ID only to players included in the same group as the players specified by the player identification information 1 and the player identification information 2 associated with the trade ID. For example, when players are grouped as shown in FIG. 16(a), the trade rate information representing the trade data for the trade ID “A000001” storing the trade condition between player 1 and player 2 shown in FIG. 6 may be presented to the game of player 3 who is included in the same group as player 1 and player 2, but is not presented to the games of player 4 and player 5 who are included in another group.

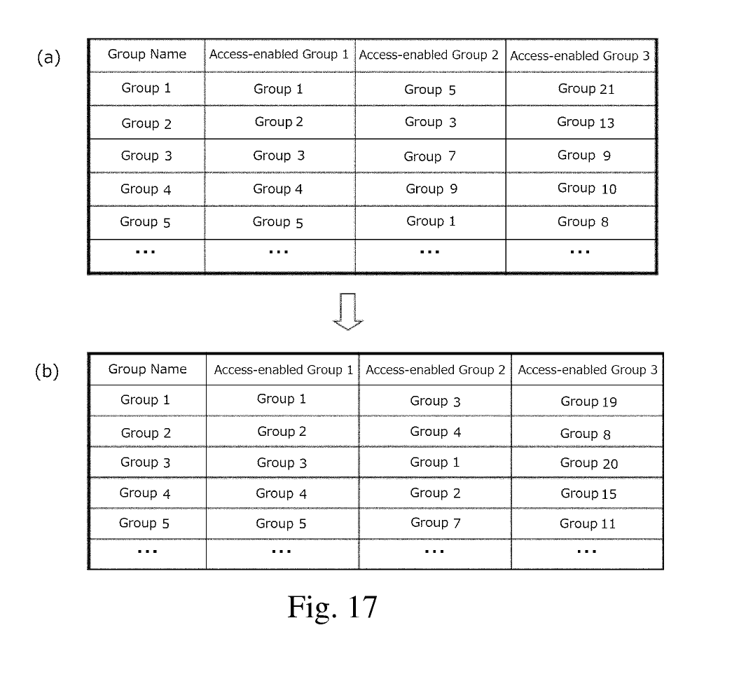

Further, the group management unit 62 may manage a plurality of groups for players in association with each other. For example, the group management unit 62 may associate a plurality of groups with each other by using a group classification table as shown in FIGS. 17(a) and 17(b). The purpose of such association of groups is, for example, to limit the players allowed to obtain, access, or browse trade data. For example, in the example shown in FIG. 17(a), group 1 is associated with groups 1, 5, and 21. In this case, the trade data related to a trade between players in group 1 can be obtained and accessed by players in groups 1, 5, and 21 but cannot be obtained or accessed by players in other groups. Herein, a group allowed to obtain and access the trade data related to a player in a certain group may be referred to as an access-enabled group. The trade rate information presenting unit 56 may present trade rate information generated with respect to trade data associated with a certain trade ID only to players included in groups associated as access-enabled groups with respect to the groups including the players specified by the player identification information 1 and the player identification information 2 associated with the trade ID. For example, the trade rate information representing the trade data for the trade ID “A00001” storing the trade condition between player 1 and player 2 may be presented only to players included in group 1, 5, or 21, if player 1 and player 2 are included in group 1.

The group updating unit 63 may regularly or irregularly alter the association of the groups in accordance with a certain algorithm. FIG. 17(b) shows an example of the group classification table after the association is altered. In the example shown in FIG. 17(b), access-enabled group 1 remains unchanged, while access-enabled groups 2 and 3 are changed. Thus, access-enabled groups may be changed partially. As is obvious from FIGS. 17(a) and 17(b), in an embodiment of the present invention, a group can be fixed as an access-enabled group with respect to the same group. That is, group 1 can be fixedly set as an access-enabled group with respect to group 1. Thus, trade rate information can be provided to players in the same group by fixing the group as an access-enabled group with respect to the same group. The example shown in FIG. 16 can be regarded as an example of the embodiment shown in FIG. 17 where a group is set to be an access-enabled group with respect to the same group.

Thus, even if players agree in reality on payment of real currency in expense of exchanged game media, game media cannot be exchanged in games between the players in different groups in the game. Since the grouping is randomly performed in accordance with a predetermined algorithm, a player cannot determine whether a trade partner in reality is in the same group in the game. Thus, players may be randomly grouped and game media can be exchanged only between players in the same group, thereby inhibiting implementation of a trade in reality to restrain real money trades.

Further, grouping of players can be altered to conceal the grouping even after a player specifies his own group. Additionally, access-enabled groups can be altered to conceal access-enabled groups. Thus, real money trade can be effectively restrained.

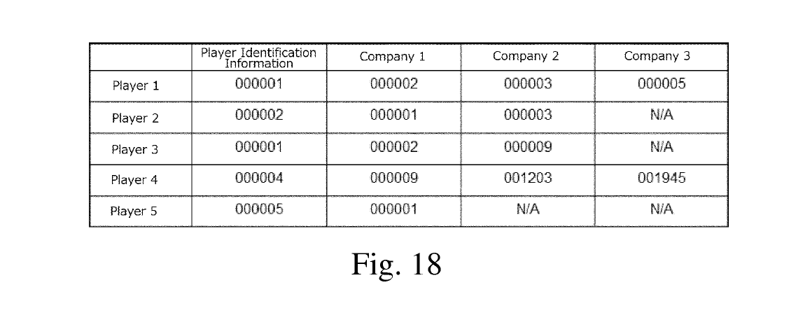

In another embodiment of the present invention, the server device 10 may further comprise a player management unit 64. The player management unit 64 can store player identification information on players of the games dynamically associated with player identification information on other players in, for example, the player management table shown in FIG. 18. For example, a player can register other players as “companies.” The players registered as “companies” can cooperate with each other to progress a game. “A company” may be registered when an offer from one player to another player is accepted. It can also be canceled when any of the players performs the processing for canceling the registration of the “company.”

In the embodiment, the trade rate information presenting unit 56 may present trade rate information generated with respect to trade data associated with a certain trade ID only to players registered as “companies” of both the players specified by the player identification information 1 and the player identification information 2 associated with the trade ID. For example, the trade rate information representing the trade data for the trade ID “A000001” storing the trade condition between player 1 and player 2 shown in FIG. 6 may be presented to the games of player 3 who is registered as “a company” of both player 1 and player 2, but is not presented to player 4 and player 5 who are not registered as “companies” of both.

Thus, even if players agree in reality on payment of real currency in expense of exchanged game media, game media cannot be exchanged in games between the players not registered as “companies” in the game. Since the maximum number of “companies” registrable is usually limited, it is unlikely that “companies” are registered only to trade game media. Thus, game media are exchanged only between players registered as “companies,” thereby inhibiting implementation of a trade in reality to restrain real money trades.

The processes and procedures described and illustrated herein may be implemented by software, hardware, or any combination thereof, as well as that explicitly stated in the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

The processes and procedures described and illustrated herein to be executed by a single device, software piece, component, or module may also be executed by a plurality of devices, software pieces, components, and/or modules. The data, table, or database described and illustrated herein to be stored in a single memory may also be distributed to and stored in a plurality of memories included in a single device or a plurality of memories which are located in a plurality of devices in a distributed manner. Furthermore, the elements of the software and hardware elements described and illustrated herein may also be integrated into a smaller number of constituent elements or separated into a larger number of constituent elements.

What is claimed is:

1. A game system comprising:
a game program storage unit configured to store a game program for performing a game;
an owned quantity storage unit configured to store owned quantities of first game medium and second game medium owned by each of a plurality of players of the game, in association with player identification information unique to each of the plurality of players;
a trade condition information storage unit configured to store first trade condition information and second trade condition information in association with each other, the first trade condition information including a trade quantity of the first game medium set by a first player included in the plurality of players, and player identification information of the first player, the second trade condition information including a trade quantity of the second game medium set by a second player included in the plurality of players, and player identification information of the second player;
a trade rate information generating unit configured to generate trade rate information, the trade rate information including the trade quantity of the first game medium and the trade quantity of the second game medium stored on the trade condition information storage unit, and the trade rate information not including player specifying information capable of specifying each of the plurality of players;
a trade rate information presenting unit configured to present the trade rate information in the game being played by a third player included in the plurality of players;
a trade condition updating request receiving unit configured to receive a first trade condition updating request from the third player, the first trade condition updating request including a trade quantity of the first game medium, the trade quantity being set by the third player;
a trade condition updating unit configured to update the first trade condition information so as to include the trade quantity and player identification information of the third player included in the first trade condition updating request, if the first trade condition updating request is received prior to trade termination time, and the trade quantity included in the first trade condition updating request is greater than the trade quantity included in the first trade condition information; and
an owned quantity updating unit configured to update the owned quantities of the first game medium and the second game medium stored on the owned quantity storage unit, based on the first trade condition information and the second trade condition information stored on the trade condition information storage unit at the trade termination time.

2. The game system according to claim 1, wherein, if the first trade condition updating request is received prior to the trade termination time, and the trade quantity included in the first trade condition updating request is greater than the trade quantity included in the first trade condition information, the owned quantity updating unit subtracts the trade quantity included in the first trade condition information at the trade termination time from the owned quantity of the first game medium associated with the player identification information of the third player in the owned quantity storage unit, and adds the trade quantity included in the second trade condition information at the trade termination time to the owned quantity of the second game medium associated with the player identification information of the third player in the owned quantity storage unit, and further, the owned quantity updating unit subtracts the trade quantity included in the second trade condition information at the trade termination time from the owned quantity of the second game medium associated with the player identification information of the second player in the owned quantity storage unit, and adds the trade quantity included in the first trade condition information at the trade termination time to the owned quantity of the first game medium associated with the player identification information of the second player in the owned quantity storage unit.

3. The game system according to claim 1,
wherein the trade rate information presenting unit presents the trade rate information in the game being played by a fourth player included in the plurality of players;
the trade condition updating request receiving unit receives a second trade condition updating request from the fourth player, the second trade condition updating request including a trade quantity of the first game medium, the trade quantity being set by the fourth player; and,
if the second trade condition updating request is received prior to trade termination time, and the trade quantity included in the second trade condition updating request is greater than the trade quantity included in the first trade condition information, the trade condition updating unit updates the first trade condition information so as to include the trade quantity and player identification information of the fourth player included in the second trade condition updating request.

4. The game system according to claim 1,
wherein the trade rate information presenting unit presents the trade rate information in the game being played by a fourth player included in the plurality of players;
the trade condition updating request receiving unit receives a second trade condition updating request from the fourth player, the second trade condition updating request including a trade quantity of the second game medium, the trade quantity being set by the fourth player; and,
if the second trade condition updating request is received prior to trade termination time, and the trade quantity included in the second trade condition updating request is greater than the trade quantity included in the second trade condition information, the trade condition updating unit updates the second trade condition information so as to include the trade quantity and player identification information of the fourth player included in the second trade condition updating request.

5. The game system according to claim 1, further comprising a trade termination time updating unit configured to update the trade termination time based on time when the first trade condition updating request is received.

6. The game system according to claim 3, further comprising a trade termination time updating unit configured to update the trade termination time based on time when the second trade condition updating request is received.

7. The game system according to claim 1, further comprising:
a group management unit configured to randomly group the plurality of players of the game into a plurality of groups and associate the plurality of groups with each other,
wherein the trade rate information presenting unit presents the trade rate information in the game being played by the third player only when a group including the third player is associated with both a group including the first player and a group including the second player.

8. The game system according to claim 1, further comprising:
a player management unit configured to store player identification information unique to each of the plurality of players of the game in dynamic association with player identification information of other players,
wherein the trade rate information presenting unit presents the trade rate information in the game being played by the third player only when the player management unit stores player identification information of the third player in association with both the player identification information of the first player and the player identification information of the second player.

9. The game system according to claim 1, wherein the trade rate information generating unit alters the trade quantity of the first game medium included in the first trade condition information and the trade quantity of the second game medium included in the second trade condition information and generates the trade rate information so as to include the altered trade quantities of the first game medium and the second game medium.

10. The game system according to claim 1, wherein the trade quantity of the first game medium included in the first trade condition information and the trade quantity of the second game medium included in the second trade condition information are selected from a limited number of preset options.

11. A method using a computer comprising the steps of:
storing game programs for performing games;
storing owned quantities of first game medium and second game medium owned by each of a plurality of players of the game, in association with player identification information unique to each of the plurality of players;
storing first trade condition information and second trade condition information in association with each other, the first trade condition information including a trade quantity of the first game medium set by a first player included in the plurality of players, and player identification information of the first player, the second trade condition information including a trade quantity of the second game medium set by a second player included in the plurality of players, and player identification information of the second player;
generating trade rate information, the trade rate information including the trade quantity of the first game medium and the trade quantity of the second game medium stored in the trade condition information storing step, the trade rate information not including player specifying information capable of specifying each of the plurality of players;
presenting the trade rate information in the game being played by a third player included in the plurality of players;
receiving a first trade condition updating request from the third player, the first trade condition updating request including a trade quantity of the first game medium, the trade quantity being set by the third player;
if the first trade condition updating request is received prior to trade termination time, and the trade quantity included in the first trade condition updating request is greater than the trade quantity included in the first trade condition information, updating the first trade condition information so as to include the trade quantity and player identification information of the third player included in the first trade condition updating request; and
updating the owned quantities of the first game medium and the second game medium stored on the owned quantity storage unit, based on the first trade condition information and the second trade condition information stored in the trade condition information storing step and remaining at the trade termination time.
